(19) United States
(12) Patent Application Publication
(10) Pub. No.: US 2026/0332871 A1
(43) Pub. Date: Oct. 22, 2026

(54) CAMERA MODULE AND ELECTRONIC DEVICE HAVING THE SAME

(71) Applicant: Rayprus Technology (Foshan) Co., Ltd., Foshan (CN)

(72) Inventor: SHENG-CHIEH LO, New Taipei (TW)

(21) Appl. No.: 19/235,571

(22) Filed: Jun. 12, 2025

(30) Foreign Application Priority Data
Apr. 18, 2025 (CN) 202510494553.5

(51) Int. Cl. H04N 23/55; H04N 23/54

(52) U.S. Cl. CPC H04N 23/55; H04N 23/54

(57) ABSTRACT

A camera module has an optical axis direction and includes a voice coil motor, a lens, a bracket, a filter, a circuit board, and an imaging sensor. The voice coil motor includes a base. The lens is connected to the base. The bracket is located at a bottom of the base, and the bracket is integrally formed with the base. The filter is connected to a side of the bracket facing away from the lens. The imaging sensor is arranged in the recess. An electronic device having the camera module is also provided.

### FIELD

The subject matter herein generally relates to a technical field of lens, and in particular to a camera module and an electronic device having the camera module.

### BACKGROUND

Currently, camera modules are widely used in electronic devices such as mobile phones and tablets. The thickness of electronic devices is developing in the direction of becoming thinner and thinner, and therefore, the requirements for the thickness of the camera modules are also becoming higher and higher.

### BRIEF DESCRIPTION OF THE DRAWINGS

Implementations of the present disclosure will now be described, by way of embodiments, with reference to the attached figures.

FIG. 1 is a diagram illustrating a camera module according to an embodiment of the present disclosure.

FIG. 2 is an exploded view illustrating a camera module according to an embodiment of the present disclosure.

FIG. 3 is a cross-sectional view illustrating a camera module according to an embodiment of the present disclosure.

FIG. 4 is a cross-sectional view illustrating a camera module according to another embodiment of the present disclosure.

FIG. 5 is a diagram illustrating an electronic device according to an embodiment of the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar components. It should be noted that references to “an” or “one” embodiment in this disclosure are not necessarily to the same embodiment, and such references mean “at least one.”

It can be understood that the term "perpendicular" is used to describe the ideal state between two components. In actual production or use, there may be a state between two components that is approximately perpendicular or equal. For example, in combination with numerical descriptions, perpendicularity can refer to the angle between two straight lines ranging from 90°±10°, perpendicularity can also refer to the dihedral angle between two planes ranging from 90°±10°, and perpendicularity can also refer to the angle between a straight line and a plane ranging from 90°±10°. The two components described as "perpendicular" may not be absolute straight lines or planes, but may be roughly straight lines or planes. From a macroscopic point of view, the components can be considered "straight lines" or "planes" if the overall extension direction is a straight line or a plane.

Unless otherwise defined, the term "multiple" in this article, when used to describe the number of components, specifically refers to the number of components being two or more.

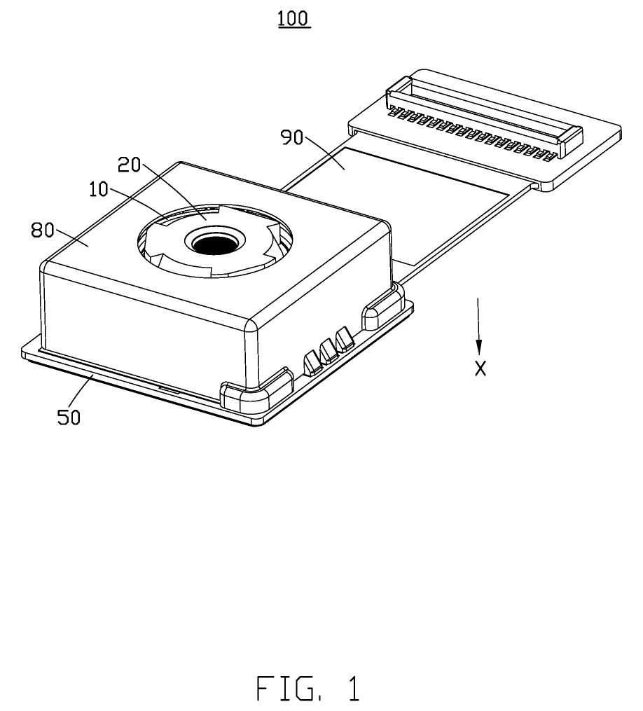

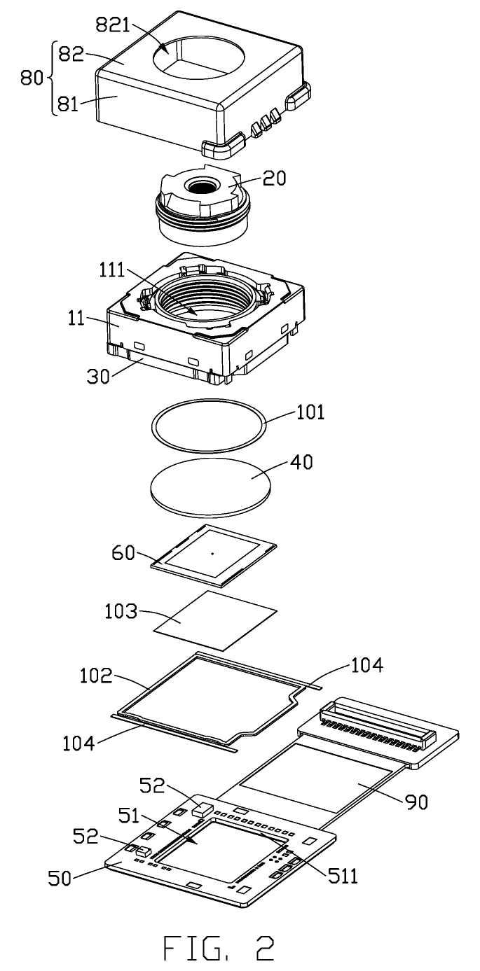

FIG. 1 illustrates an embodiment of a camera module 100. Referring to FIGS. 1-3, the camera module 100 includes a voice coil motor 10, a lens 20, a bracket 30, a filter 40, a circuit board 50 and an imaging sensor 60. The voice coil motor 10 includes a base 11, and the lens 20 is connected to the base 11. The base 11 is used to drive the lens 20 to move to achieve automatic focus. The bracket 30 is located at a bottom of the base 11 and is integrally formed with the base 11. The filter 40 is connected to a side of the bracket 30 facing away from the lens 20. The circuit board 50 is connected to the bracket 30, and the circuit board 50 is located on a side of the filter 40 facing away from the lens 20. The circuit board 50 is provided with a recess 51. The imaging sensor 60 is arranged in the recess 51.

The present application reduces the overall height of the bracket 30 and the base 11 by integrally forming the bracket 30 with the base 11, and the imaging sensor 60 is received in the recess 51, which is conducive to reducing the overall height of the camera module 100, and is convenient for controlling a distance between the imaging sensor 60 and the filter 40, thereby improving the imaging quality.

In some embodiments, the bracket 30 is integrally injection molded with the base 11.

In some embodiments, a receiving cavity 111 penetrates the base 11 along a first direction X. The lens 20 is arranged in the receiving cavity 111 and is threadedly connected to the base 11. The first direction X is a height direction of the circuit board 50.

In some embodiments, the bracket 30 may include an extension portion 31 extending in a direction perpendicular to an axial direction of the camera module 100, and the filter 40 is connected to a side of the extension portion 31 facing the circuit board 50. The extension portion 31 has a first opening 311, the filter 40 covers the entire first opening 311 and a portion of the filter 40 is exposed from the first opening 311. A portion of the lens 20 may be located in the first opening 311 and is spaced apart from the filter 40 along the first direction X.

In some embodiments, the camera module 100 may include a first adhesive 101, and the filter 40 is bonded to the side of the extension portion 31 facing the circuit board 50 through the first adhesive 101.

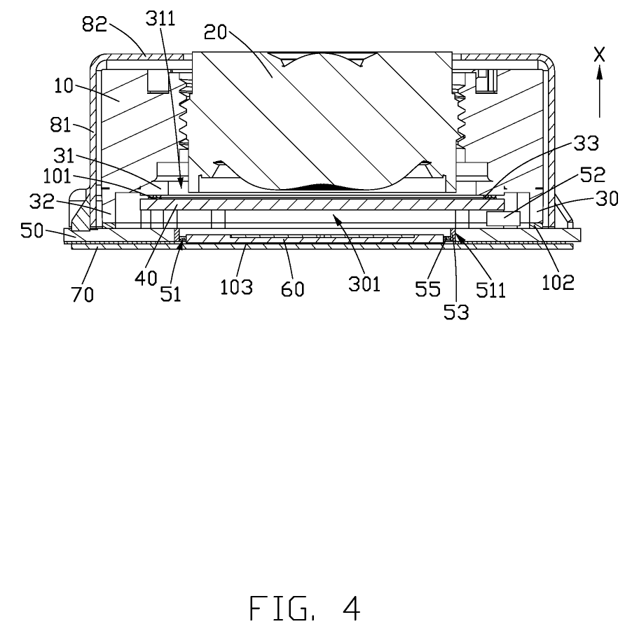

In some embodiments, referring to FIG. 4, the bracket 30 may further include at least one first protrusion 33 on the side of the extension portion 31 facing the circuit board 50, and the filter 40 is connected to a side of each of the at least one first protrusion 33 facing the circuit board 50. A height of each of the at least one first protrusion 33 is adjustable. By adjusting the height of the first convex portion, it is convenient to adjust a distance between the lens 20 and the filter 40, which is conducive to improving the imaging quality.

Each of the at least one first protrusion 33 may be annular and surround an optical axis direction of the camera module 100.

In some embodiments, the bracket 30 may further includes a second protrusion 32 extending toward the circuit board 50, the second protrusion 32 is connected to the circuit board 50, and a receiving space 301 communicating with the receiving cavity 111 is formed between the bracket 30 and the circuit board 50, which is convenient for installing the filter 40 and adjusting the distance between the filter 40 and the imaging sensor 60, which is conducive to improving the imaging quality.

In some embodiments, the camera module 100 may further include a second adhesive 102, and the second protrusion 32 is bonded to the circuit board 50 through the second adhesive 102.

In some embodiments, along the first direction X, the filter 40 may cover the entire recess 51, and a projection of the imaging sensor 60 is located within a projection of the filter 40, which is conducive to eliminating stray light interference and improving the imaging quality. It can be understood that the first direction X is the optical axis direction.

In some embodiments, a first element 52 may be provided at a corner of the circuit board 50, and along the first direction X, the projection of the filter 40 may be separated from a projection of the first element 52, thereby reducing the influence of the filter 40 on the first element 52, and reducing the influence of the stacking of the filter 40 and the first element 52 in the first direction X on the height of the camera module 100.

In some embodiments, along the first direction X, the projection of the filter 40 may be circular. The first element 52 may include at least one of a driver integrated circuit module and a read-only memory. The filter 40 may be in other shapes, as long as it covers the recess 51 and is separated from the first element 52.

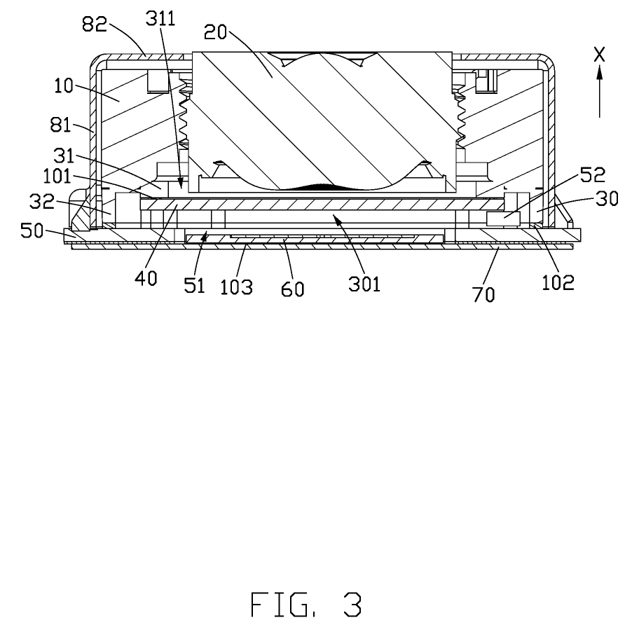

Referring to FIG. 3, in some embodiments, along the first direction X, the recess 51 does not penetrate the circuit board 50, and the imaging sensor 60 is bonded to the circuit board 50, which is conducive to reducing the height of the camera module 100

In some embodiments, along the first direction X, a surface of the imaging sensor 60 facing the lens 20 does not exceed a surface of the circuit board 50 facing the lens, that is, the surface of the circuit board 50 facing the lens is located between the surface of the imaging sensor 60 facing the lens 20 and the lens 20, or the surface of the circuit board 50 facing the lens 20 is flush with the surface of the image sensor 60 facing the lens 20, which is further conducive to reducing the height of the camera module 100. The circuit board 50 surrounds the imaging sensor 60, which is conducive to reducing the damage to the imaging sensor 60 caused by external force impact or vibration, thereby reducing the risk of failure of the imaging sensor 60

In some embodiments, along the first direction X, the recess 51 may extend through the circuit board 50, and the camera module 100 may further include an outer protective plate 70, which is connected to a side of the circuit board 50 facing away from the filter 40. The imaging sensor 60 is connected to the outer protective plate 70. The circuit board 50 and the imaging sensor 60 are protected by the outer protective plate 70, and the heat of the imaging sensor 60 can be transferred to the outside of the camera module 100 through the outer protective plate 70, which is conducive to heat dissipation of the imaging sensor 60. In at least one embodiment, the outer protective plate 70 may include a metal plate.

In some embodiments, the camera module 100 may further include a third adhesive 103, and the imaging sensor 60 is bonded to the outer protective plate 70 through the third adhesive 103.

In some embodiments, referring to FIG. 4, the recess 51 is defined by a wall 511 surrounding the imaging sensor 60, and the wall 511 may be covered with a metal layer 53, and the metal layer 53 is separated from the imaging sensor 60, which is conducive to shielding the influence of external electromagnetic interference on the analog signal of the imaging sensor 60. In at least one embodiment, the metal layer 53 may be formed by chemical copper plating or electroplating.

In some embodiments, the imaging sensor 60 may be connected to the metal layer 53 by an insulating thermal conductive adhesive 55 to reduce the risk of short circuit between the imaging sensor 60 and the metal layer 53. The heat of the imaging sensor 60 can also be transferred to a heat dissipation layer of the circuit board 50 through the insulating thermal conductive adhesive 55, which is conducive to heat dissipation.

In some embodiments, the camera module 100 further includes a housing 80, the housing 80 includes a side wall 81 and a top wall 82, the side wall 81 is connected to the top wall 82, and the side wall 81 is connected to the circuit board 50. The top wall 82 is provided with a through hole 821, at least part of the lens 20 is exposed from the through hole 821, and external light is emitted to the lens 20 through the through hole 821.

In some embodiments, the camera module 100 may further include a fourth adhesive 104, and the side wall 81 is bonded to the circuit board 50 through the fourth adhesive 104.

In some embodiments, along the first direction X, a distance between the base 11 and the top wall 82 is not greater than 0.144 mm, which is conducive to reducing the height of the camera module 100.

In some embodiments, along the first direction X, a distance between the bracket 30 and a driving integrated circuit module is not greater than 0.328 mm, which is conducive to reducing the height of the camera module 100.

In some embodiments, along the first direction X, the height of the camera module 100 does not exceed 3.757 mm, which is conducive to reducing the thickness of the electronic device including the camera module 100.

In some embodiments, the camera module 100 may further include a flexible connecting board 90, and the flexible connecting board 90 is electrically connected to the circuit board 50. The flexible connecting board 90 is used to connect an external electronic device.

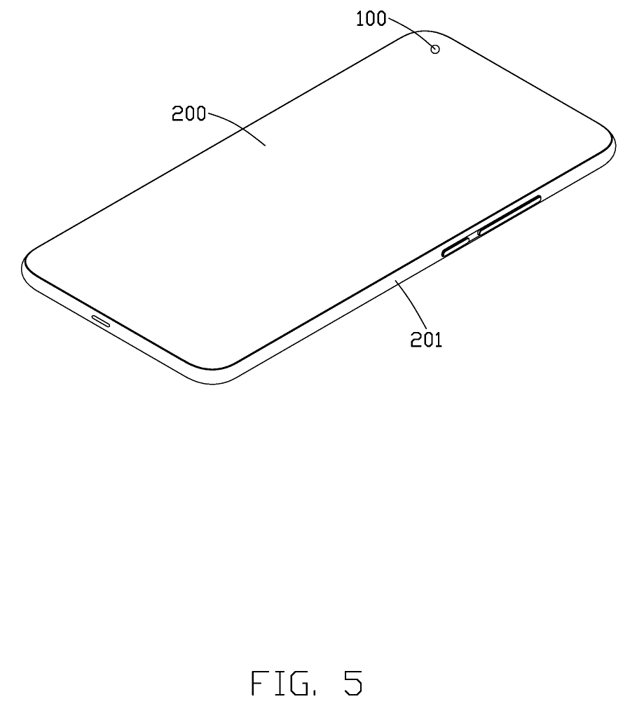

FIG. 5 illustrates an embodiment of an electronic device 200. The electronic device 200 includes the camera module 100. The electronic device 200 further includes a housing 201 for receiving the camera module 100. The electronic device 200 may be a mobile phone, a tablet computer, an e-reader, a laptop computer, or a wearable device. In the electronic device 200, the bracket 30 and the base 11 are integrally formed to reduce the overall height of the bracket 30 and the base 11. The imaging sensor 60 is arranged in the recess 51 to reduce the overall height of the camera module 100, thereby reducing the overall height of the electronic device 200, and it is convenient to control the distance between the imaging sensor 60 and the filter 40 to improve the imaging quality.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A camera module defining an optical axis direction and comprising:
a voice coil motor comprising a base;
a lens connected to the base;
a bracket located at a bottom of the base, wherein the bracket is integrally formed with the base;
a filter connected to a side of the bracket facing away from the lens;
a circuit board connected to the bracket and located on a side of the filter facing away from the lens, wherein the circuit board comprises a recess; and
an imaging sensor arranged in the recess.

2. The camera module of claim 1, further comprising a first protrusion, wherein the first protrusion extends from the side of bracket facing away from the lens toward the circuit board, the first protrusion is spaced apart from the circuit board, the filter is connected to a side of the first protrusion facing the circuit board.

3. The camera module of claim 2, wherein a height of the first protrusion along the optical axis direction is adjustable.

4. The camera module of claim 2, wherein the first protrusion is annular and surrounds the optical axis direction.

5. The camera module of claim 1, wherein along the optical axis direction, the filter covered an entirety of the recess, and a projection of the imaging sensor is located on the circuit board within a projection of the filter on the circuit board.

6. The camera module of claim 1, further comprising a first element, wherein the first element is arranged at a corner of the circuit board, and along the optical axis direction, a projection of the filter on the circuit board is separated from a projection of the first element on the circuit board.

7. The camera module of claim 1, wherein a surface of the circuit board r facing the lens is located between the lens and a surface of the imaging sensor facing the lens, or the surface of the imaging sensor facing the lens is flush with the surface of the image sensor facing the lens.

8. The camera module of claim 1, wherein along the optical axis direction, the recess penetrates a portion of the circuit board.

9. The camera module of claim 1, wherein along the optical axis direction, the recess extends through the circuit board, the camera module further comprises an outer protective plate, the outer protective plate is connected to a side of the circuit board facing away from the filter, the imaging sensor is connected to the outer protective plate.

10. The camera module of claim 1, wherein the circuit board comprises a wall around the optical axis direction for defining the recess, the wall surrounds the imaging sensor and is covered with a metal layer, the metal layer is separated from the imaging sensor, the camera module further comprises an insulating thermal conductive adhesive connecting the imaging sensor with the metal layer.

11. An electronic device comprising:
a housing; and
a camera module in the housing defining an optical axis direction and comprising:
a voice coil motor comprising a base;
a lens connected to the base;
a bracket located at a bottom of the base, wherein the bracket is integrally formed with the base;
a filter connected to a side of the bracket facing away from the lens;
a circuit board connected to the bracket and located on a side of the filter facing away from the lens, wherein the circuit board comprises a recess; and
an imaging sensor arranged in the recess.

12. The electronic device of claim 11, further comprising a first protrusion, wherein the first protrusion extends from the side of bracket facing away from the lens toward the circuit board, the first protrusion is spaced apart from the circuit board, the filter is connected to a side of the first protrusion facing the circuit board.

13. The electronic device of claim 12, wherein a height of the first protrusion along the optical axis direction is adjustable.

14. The electronic device of claim 12, wherein the first protrusion is annular and surrounds the optical axis direction.

15. The electronic device of claim 11, wherein along the optical axis direction, the filter covered an entirety of the recess, and a projection of the imaging sensor on the circuit board is located within a projection of the filter on the circuit board.

16. The electronic device of claim 11, wherein further comprising a first element, wherein the first element is arranged at a corner of the circuit board, and along the optical axis direction, a projection of the filter on the circuit board is separated from a projection of the first element on the circuit board.

17. The electronic device of claim 11, wherein a surface of the circuit board facing the lens is located between the lens and a surface of the imaging sensor facing the lens, or the surface of the imaging sensor facing the lens is flush with the surface of the image sensor facing the lens.

18. The electronic device of claim 11, wherein along the optical axis direction, the recess penetrates a portion of the circuit board.

19. The electronic device of claim 11, wherein along the optical axis direction, the recess extends through the circuit board, the camera module further comprises an outer protective plate, the outer protective plate is connected to a side of the circuit board facing away from the filter, the imaging sensor is connected to the outer protective plate.

20. The electronic device of claim 11, wherein the circuit board comprises a wall around the optical axis direction for defining the recess, the wall surrounds the imaging sensor and is covered with a metal layer, the metal layer is separated from the imaging sensor, the camera module further comprises an insulating thermal conductive adhesive connecting the imaging sensor with the metal layer.
